(19) United States
(12) Patent Application Publication
(10) Pub. No.: US 2010/0098917 A1
(43) Pub. Date: Apr. 22, 2010

(54) AUTOMOTIVE GLAZINGS

(75) Inventor: Michael Lyon, Bickerstaffe (GB)

Correspondence Address: BUCHANAN, INGERSOLL & ROONEY PC, POST OFFICE BOX 1404, ALEXANDRIA, VA, 22313-1404, US

(73) Assignee: Pilkington Group Limited, St. Helens ,Merseyside (GB)

(21) Appl. No.: 12/444,830

(22) PCT Filed: Oct. 18, 2007
(86) PCT No.: PCT/GB2007/050646

§ 371 Date: Apr. 8, 2009

(30) Foreign Application Priority Data
Oct. 19, 2006 (GB) 0620709.6

(51) Int. Cl. B41M 3/00; B05D 5/06; B32B 3/10; B60J 3/00

(52) U.S. Cl. 428/195.1; 427/164

(57) ABSTRACT

A method of printing an automotive glazing component and an automotive glazing component are described. The method comprises the steps of: printing a first portion, having a width, of the glazing component using an ink spray to provide a first ink density, the ink density being constant across the width of the first portion; printing a second portion, also having a width, of the glazing component using an ink spray; and leaving a third portion, also having a width, of the glazing component, adjacent the second portion, unprinted, such that there is a zero ink density on the surface of the third portion of the glazing component. The step of printing the second portion comprises varying the output of the ink spray to produce a non-constant ink density on the surface of the second portion. By providing a non-constant ink-density on the surface of the glazing, it is possible to provide low-cost high-resolution non-constant optical and thermal transmission regions on automotive glazings.

This invention relates to the printing of automotive glazing components, in particular, automotive glazings with a printed region having a non-constant ink density.

Automotive glazings, such as windscreens and backlights, are typically printed with a solid band print around the periphery of the glazing, known as an obscuration band, which appears as a black or dark-coloured band around the edge of the glass. The obscuration band covers the adhesive on the glazing, and is both aesthetic and functional. Not only is the adhesive hidden from view, but damage by UV light is also prevented.

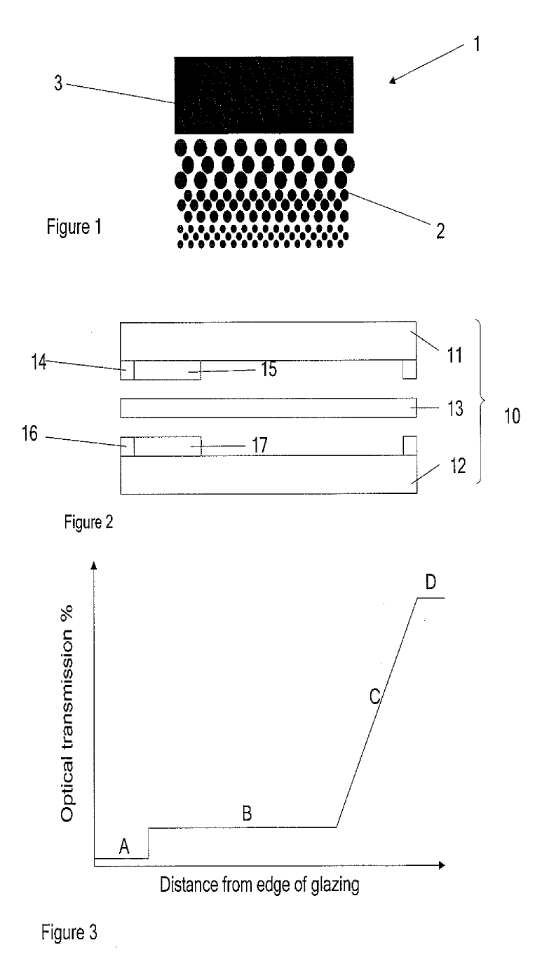

The inner edge (that closest to the vision area of the glazing) of the obscuration band typically comprises a fade-out region. This is where a pattern of dots, decreasing in size towards the centre of the glazing, is used to form the inner edge of the obscuration band. FIG. 1 illustrates the type of pattern used to form the inner edge of the obscuration band. The pattern 1 comprises a series of dots 2 having a diameter which decreases with increasing distance away from the solid obscuration band print 3. A harsh or strong edge to the obscuration band can cause the driver of the vehicle to be unduly aware of the edge of the obscuration band, whereas a gradual change in the light transmittance across the obscuration band makes the edge less noticeable.

Obscuration bands are typically printed onto the surface of an automotive glazing before the firing and bending using screen printing techniques. Printing takes place in a temperature controlled printing room. A screen having a negative pattern of the obscuration band is placed onto the glazing. The negative is transferred to the glazing as a positive by holding the screen against the glass and applying coats of a black, non-conductive ink, using a squeegee. Once the ink has been applied to the glazing, the glazing is removed from the printing station and placed in a drying cabinet. The printed pattern is then fired, revealing the positive of the pattern of the screen printed onto the glazing.

Whilst screen-printing is a reliable, accurate and low-cost approach to printing onto automotive glazings, one problem is the level of resolution possible for various images. This is due to the need for the screen to contact the surface of the glazing during the printing process, and therefore, for example, the size and spacing of the dots forming the edge of the obscuration band is limited by the screen mesh and ink properties. It is therefore not possible to create a genuine fade-out region where the optical and thermal transmission of the printed area gradually increases to that of clear glass.

Another situation where resolution of the printed pattern is an issue is the provision of a shadeband across the width of the upper region of a windscreen or across the entire surface of a rooflight. A shadeband is a region of non-constant optical and thermal transmission which helps to reduce glare. The shadeband is typically coloured (green, grey or blue) and has the region of lowest optical and thermal transmission at the upper edge (nearest the periphery of the windscreen) and highest optical and thermal transmission at the lower edge (nearest the vision area of the windscreen). This is therefore a fade-out region, as with the obscuration band. In the case of a rooflight, reduced optical and thermal transmission is achieved by printing a pattern onto the glazing which lets through sufficient light to illuminate the interior of the vehicle in which it is installed, whilst stopping sufficient UV and IR rays to prevent glare and overheating of the passenger compartment.

Windscreens and backlights, and increasingly, rooflights, are formed from laminated glazings, comprising two plies of glass having an interlayer laminated therebetween. Rather than using screen-printed images to form shade regions, the most commonly used solution for laminated glazing is to employ a coloured interlayer in the shadeband region, where the interlayer material may have a fade-out region, or to use heavily tinted glass in a rooflight. Both of these options have an increased cost compared with using standard automotive clear glass and standard automotive PVB.

It is therefore desirable to be able to find a way to provide low-cost high-resolution non-constant optical and thermal transmission regions on automotive glazings.

The present invention aims to address these problems by providing a method of printing an automotive glazing component, comprising printing a first portion, having a width, of the glazing component using an ink spray to provide a first ink density, the ink density being constant across the width of the first portion, printing a second portion, also having a width, of the glazing component using an ink spray, leaving a third portion, also having a width, of the glazing component, adjacent the second portion, unprinted, such that there is a zero ink density on the surface of the third portion of the glazing component, wherein the step of printing the second portion comprises varying the output of the ink spray to produce a non-constant ink density on the surface of the second portion.

By providing a non-constant ink-density on the surface of the glazing, it is possible to provide low-cost high-resolution non-constant optical and thermal transmission regions on automotive glazings.

Preferably, the first ink density provides an optical transmission of less than 30%, when measured with CIE Illuminant A. More preferably, the first ink density provides an optical transmission in the range 5%-10%, when measured with CIE Illuminant A. Preferably, the unprinted region has an optical transmission greater than 70%, when measured with CIE Illuminant A.

Preferably, the ink spray is provided using an airbrush system. The colour of the ink used may be one of: black, blue, green and grey.

Preferably, the second region is a fade-out region for a shadeband. Alternatively, the second region may be a fade-out region for an obscuration band.

The component may be a ply of annealed or semi-toughened glass, or a ply of bent glass. Alternatively, the component may be a ply of interlayer material.

The present invention also provides an automotive glazing component, printed using the method of the present invention, having an optical transmissivity, the component comprising three portions, each having a width, a first solid printed portion having a constant optical transmissivity across its width, a second solid printed portion, adjacent the first; and a third portion, adjacent the second printed portion, remaining unprinted and having the same optical transmissivity as the automotive glazing component, wherein the optical transmissivity of the second portion changes smoothly across the width of the portion from the optical transmissivity of the first portion, adjacent the first portion, to the optical transmissivity of the automotive glazing component, adjacent the unprinted region.

Preferably, the rate of change of optical transmissivity per mm across the width of the second region is in the range 0.28%/mm-0.83%/mm.

The invention also provides for use of an airbrush printing process to provide a solid printed region, having a width, on the surface of an automotive glazing component, wherein the printed region has a non-constant optical transmission across its width.

The invention will now be described by way of example only, with reference to the accompanying drawings, in which:

FIG. 1, referred to above, illustrates the dot pattern used in a fade-out region;

FIG. 2 is a schematic exploded cross section showing the positions where shadeband areas and obscuration bands may be printed on laminated glazings;

FIG. 3 is a schematic plot illustrating the optical transmission characteristics of the obscuration band and shadeband region obtainable using airbrush printing techniques;

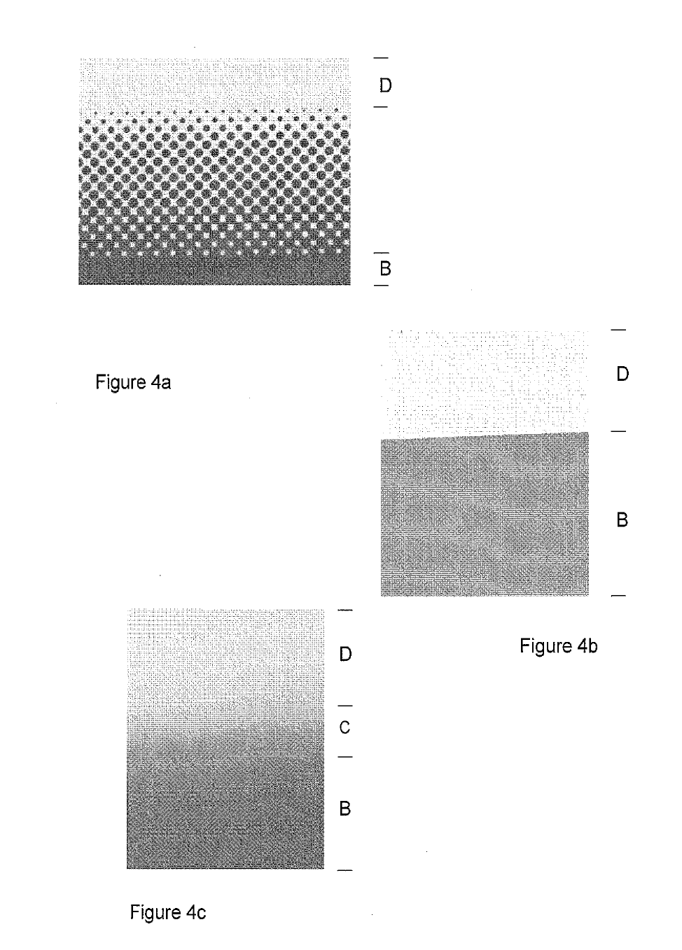

FIG. 4a is a photograph showing a screen printed dot pattern in a fade-out region;

FIG. 4b is a photograph showing a screen printed obscuration band region;

FIG. 4c is a photograph showing a genuine fade-out region; and

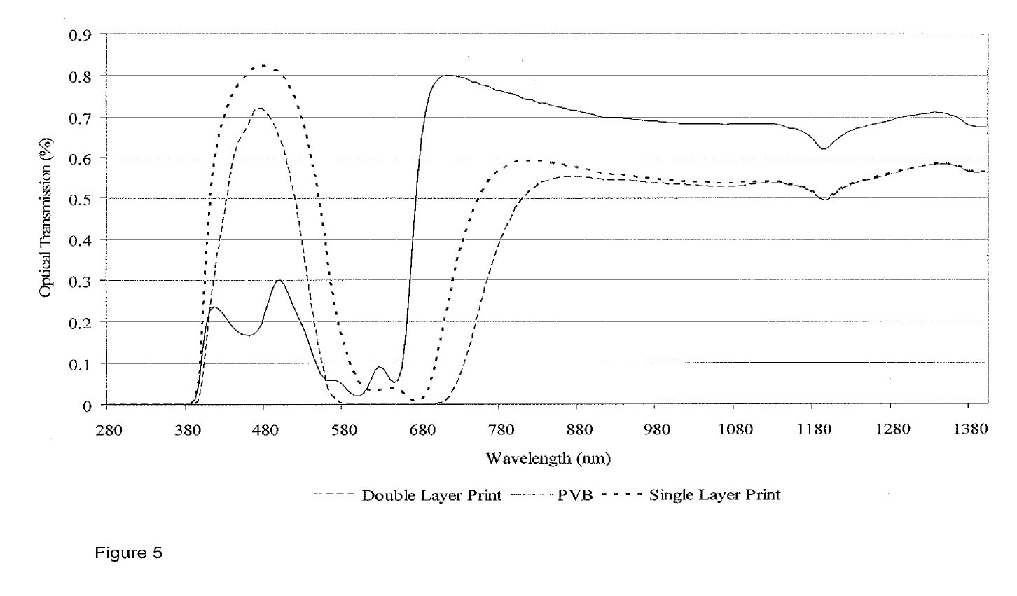

FIG. 5 is a plot showing the optical transmission characteristics of a commercially available coloured PVB interlayer material, a single print region and a double print region, both obtained using airbrush techniques.

In accordance with the present invention, non-contact printing methods may be used to print a genuine fade-out region, and therefore obscuration bands and shadebands employing such regions. Non-contact printing methods may also be used to print reduced optical and thermal transmission glazings, such as rooflights. As described above, the resolution of a screen printed image is limited by the need for the screen to contact the surface of the glazing during printing. However, the resolution of images printed using non-contact printing methods is not limited in this manner, as no contact takes place between the print head and the surface of the glazing being printed.

A preferred method of non-contact printing is airbrush printing. A basic airbrush comprises a nozzle connected to a reservoir of fluid (ink, dye or paint) held at atmospheric pressure and a trigger connected to a supply of compressed air. When the trigger is pulled, compressed air is passed through a venturi, creating a local reduction in air pressure and causing the fluid to be drawn up from the reservoir. The high velocity of the compressed air causes the fluid to atomise into tiny droplets as it passes a fluid metering component, and forces the droplets out of the nozzle onto a substrate. The trigger may control the air flow and the fluid flow either via a single action (where fluid and air flow are controlled together) or via dual action (where fluid and air flow are controlled independently). The fluid itself may be fed from the reservoir either under gravity or using a siphon feed system. A fine atomised spray can be created by mixing the fluid and air within the tip of the nozzle, whereas a coarser spray is achieved by mixing the fluid and air outside the tip of the nozzle.

Airbrush systems may be used to print obscuration bands and shadebands onto automotive glazings. FIG. 2 is a schematic exploded cross section showing the positions where shadeband areas and obscuration bands may be printed on laminated glazings. A laminated glazing 10 comprises outer 11 and inner 12 plies of annealed or semi-toughened glass having an interlayer 13 laminated therebetween. The plies of glass 11 12 may be clear (having an optical transmittance of 88% with CIE Illuminant A) or tinted, and the interlayer 13 is preferably formed of polyvinyl butyral (PVB). The interlayer may contain wiring for heating, lighting and aerial circuits. Preferably, the unprinted region of the glazing has an optical transmission (measured using CIE Illuminant A) of greater than 70%.

The obscuration band 14 and shadeband region 15 may be printed onto the inner side of the outer ply of glass 11 (commonly known as “surface 2 printing”). Alternatively, the obscuration band 16 and shadeband region 17 may be printed onto the outer surface of the inner ply of glass 12 (commonly known as “surface 3 printing”). Printing typically takes place on flat glass, cut to size, such that firing and bending are required to ensure the finished glazing is in the correct shape. Therefore, once printed, the ply of glass is allowed to dry under controlled temperature and humidity conditions, before firing.

Typically, the firing stage is combined with a bending stage if the windscreen is to be bent to shape after printing. For laminated structures, the inner and outer plies may be bent and fired in the same configuration that they will be laminated in, in order to ensure that the plies fit together when the laminate layer is placed in between.

If either of the inner sides of the plies in the laminated structure are to be printed, as described above, then a pre-firing stage may be necessary before the plies can undergo any bending. In a pre-firing stage, the printed ply, whilst still flat, is dried and then fired to drive off any organic ink components and to partially sinter the ink Once cooled, the ply can then be placed next to the unprinted ply and both fired and bent to shape. Such pre-firing processes are well known in the art.

FIG. 3 is a schematic plot illustrating the optical transmission characteristics of the obscuration band and shadeband region obtainable using airbrush printing techniques. Region A represents the obscuration band region, at the top edge of the glazing. Here the optical transmission in the visible region is below 10%, preferably below 1%. This effectively provides a solid print, opaque region, obtained by spraying using the airbrush nozzle at a constant air pressure and a constant distance from the glass. Region B represents the shadeband region, extending for approximately 700 mm in the case of a cielo windscreen and for approximately 160 to 200 mm in a standard windscreen, and typically having an optical transmission in the visible region of less than 30%, preferably in the range 5% to 10%. Region C represents the fade-out band, and is the region where the benefits of airbrush printing are most apparent. Adjacent the shadeband region, the optical transmission in region C is approximately the same as the shadeband region, but increases gradually away from the shadeband region towards the vision region of the glazing. At the point when the fade-out band reaches region D, the optical transmission is that of a laminated glazing comprising both clear glass (optical transmission of 88% with CIE Illuminant A) and clear (untinted) PVB. Preferably, the rate of change of transmissivity per mm of glazing in this region is in the range 0.28%/mm to 0.83%/mm. The graduated optical transmission of the fade-out band is achieved by decreasing the density of the ink to increase the optical transmission. Such an effect is obtained by varying the output of the ink spray, by varying air pressure at the nozzle, and the distance between the nozzle and the surface of the glass being sprayed. By using the airbrush technique, it is possible to achieve shadebands giving similar optical properties to conventional PVB shadebands, whilst having genuine fade-out regions, as described below.

FIGS. 4a, 4b and 4c illustrate a comparison between traditional screen printing techniques and airbrush printing techniques to form shadeband regions on automotive glazings. FIG. 4a is a photograph showing a screen printed dot pattern in a fade-out region, and is similar to FIG. 1 in that the fade-out region can only be produced by printing a series of dots having decreasing radii. FIG. 4a is labelled to show where each region would be found on the schematic chart of FIG. 3. By using screen printing techniques, only regions B and D are realistically achievable.

FIG. 4b is a photograph showing a screen printed obscuration band region. A sharp boundary delineating the printed and non-printed regions is seen, corresponding to regions B and D in FIG. 3.

FIG. 4c is a photograph showing a genuine fade-out region obtained using airbrush printing techniques. A printed region having a smoothly varying optical transmissivity across its width, varying between the optical transmissivity of the printed shadeband region B, adjacent this region, and the optical transmissivity of the unprinted glazing at region D, adjacent the unprinted region is seen in region C. The air-brush printed region is solid, that is, does not comprise a discrete pattern of printed shapes.

FIG. 5 is a plot showing the optical transmission characteristics of a commercially available coloured PVB interlayer material, a single print region and a double print region, both obtained using airbrush techniques. The coloured PVB interlayer material used comprised a blue shadeband region, available commercially from Sekisui Chemical Co. Ltd. The printed shadebands were provided using a blue sol-gel ink All measurements were taken under standard conditions using CIE Illuminant A.

Both single and double printed regions showed a difference in optical transmission to the PVB interlayer material around 480 nm. However, both single and double printed regions had a lower optical transmission than the PVB interlayer material at the red/near IR end of the measured spectrum. It is to be expected therefore that either a single or double printed shadeband region, provided using airbrush techniques and having a genuine fade-out region will give similar if not better anti-glare performance to a PVB interlayer shadeband in an automotive glazing. By printing the fade-out region to produce a varying ink density on the surface of the glass, it is possible to provide low-cost high-resolution non-constant optical and thermal transmission regions on automotive glazings.

As an alternative to printing the glass whilst flat, and then bending and firing, it is possible to print the glass using organic inks once each ply has already been fired and bent. This is as a result of the airbrush technique being a flexible, non-contact printing technique, such that contours on the glass are not an obstacle to good quality prints, as with screen printing and other contact printing techniques. In addition, rather than printing a shadeband region across the entire width of the upper region of a glazing, a window may be provided in the printed region to allow sensors which require high optical transmissivity to function, such as rain sensors, to be sited within the shadeband region. The obscuration band may also contain a window to allow a windscreen wiper to be aligned with a heated wiper parking area, once the glazing is fitted into a vehicle. The colours used for the obscuration band and shadeband regions may be any desired single or multiple colour combination. Typically, however, the obscuration band region is a solid black print, and shadebands shades of grey, blue and green, typically matching automotive glazings such as GALAXSEE™ and SUNDYM™, available from Pilkington Group Limited in the UK. However, although these ink colours are preferable, any colour of ink may be used, depending on the preferences of the end user.

Although the above description is concerned with the use of airbrush printing methods to print onto glass, it may be desirable to print obscuration bands and/or shadebands onto other automotive glazing components, such as the interlayer material used in the construction of the laminated glazing instead of or as well as printing onto plies of glass. In addition, other glazing components, for example, plies of a polymer material such as polycarbonate, may be printed using the method of the present invention.

1. A method of printing an automotive glazing component, comprising:
printing a first portion, having a width, of the glazing component using an ink spray to provide a first ink density, the ink density being constant across the width of the first portion;
printing a second portion, also having a width, of the glazing component using an ink spray;
leaving a third portion, also having a width, of the glazing component, adjacent the second portion, unprinted, such that there is a zero ink density on the surface of the third portion of the glazing component,
wherein the step of printing the second portion comprises varying the output of the ink spray to produce a non-constant ink density on the surface of the second portion.

2. The method of claim 1, wherein first ink density provides an optical transmission of less than 30%, when measured with CIE Illuminant A.

3. The method of claim 2, wherein the first ink density provides an optical transmission in the range 5%-10%, when measured with CIE Illuminant A.

4. The method of claim 1, wherein the unprinted region has an optical transmission greater than 70%, when measured with CIE Illuminant A.

5. The method of claim 1, wherein the ink spray is provided using an airbrush system.

6. The method of claim 5, wherein the colour of the ink used is one of: black, blue, green and grey.

7. The method of claim 1, wherein the second region is a fade-out region for a shadeband.

8. The method of claim 1, wherein the second region is a fade-out region for an obscuration band.

9. The method of claim 1, wherein the component is a ply of annealed or semi-toughened glass.

10. The method of claim 1, wherein the component is a ply of bent glass.

11. The automotive glazing component of claim 1, wherein the component is a ply of interlayer material or a polymer material.

12. An automotive glazing component, printed using the method of claim 1, having an optical transmissivity, the component comprising three portions, each having a width:
a first solid printed portion having a constant optical transmissivity across its width;
a second solid printed portion, adjacent the first; and
a third portion, adjacent the second printed portion, remaining unprinted and having the same optical transmissivity as the automotive glazing component;
wherein the optical transmissivity of the second portion changes smoothly across the width of the portion from the optical transmissivity of the first portion, adjacent the first portion, to the optical transmissivity of the automotive glazing component, adjacent the unprinted region.

13. The automotive glazing component of claim 12, wherein the rate of change of optical transmissivity per mm across the width of the second region is in the range 0.28%/mm-0.83%/mm.

14. Use of an airbrush printing process to provide a solid printed region, having a width, on the surface of an automotive glazing component, wherein the printed region has a non-constant optical transmission across its width.
